(19) United States
(12) Patent Application Publication
(10) Pub. No.: US 2007/0211343 A1
(43) Pub. Date: Sep. 13, 2007

(54) Method and apparatus for reducing optical reflections

(76) Inventors: Stephan Clark, Corvallis, OR (US); Scott A. Lerner, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/372,533

(22) Filed: Mar. 10, 2006

(51) Int. Cl. G02B 27/00

(52) U.S. Cl. 359/577

(57) ABSTRACT

Methods and apparatuses are provided for reducing reflections in optical systems. Two optical elements are spaced apart from each other with first surfaces facing each other to form a gap there between. Reflections from a light beam passing through the two optical elements are at a non-zero angle with respect to the light beam. A second surface of one of the optical elements is essentially perpendicular to the light beam.

### BACKGROUND

In optical systems, it is desirable to transfer light from one optical element to another with a minimum amount of reflection. A reflection can occur if light passes through a medium with one index of refraction, such as air, and enters another medium with another index of refraction, such as glass. By way of example, many are familiar with the reflection that occurs from the surface of a seemingly transparent window. Many opto-electronic components have a similar packaging window to seal opto-electronic devices and to protect the devices from damage. For example a photodiode detector, such as charge coupled device or a junction photodiode, is sealed in this manner. Other optical components such as optical light modulators or interference filters are similarly sealed.

If optical systems are designed using the previously mentioned examples of optical components, or if other optical elements such as lenses are used, reflections may cause undesirable artifacts. One such artifact is ghosting. Ghosting occurs if the reflected light superimposes on the transmitted light. This effect is particularly noticeable, for instance, in a projection system where an otherwise dark image has a bright spot such as rendering a white boat on a dark sea. The reflected image may appear spatially offset from the desired image and therefore appear as a ghost. Controlling the reflected light is required to minimize ghosting.

Undesirable ghost reflections have been managed by applying antireflective coatings to optical elements, or by filling the area between optical elements with a material having a refractive index similar to the refractive index of the optical elements. Managing ghost reflections using these techniques has had limited success.

Uncoated glass with an index of refraction of about 1.5 reflects about 4% of the light normal to the surface. Commercially available antireflective coatings can significantly reduce this reflection. For example, the coating magnesium fluoride reduces the reflection to about 2% and a dielectric multilayer stack can reduce the reflection to about 0.5%. Unfortunately, even a 0.5% reflection coming from a highly ghost sensitive region of an optical system can be visible, resulting in significant ghosting. Visible ghosting is unacceptable in high contrast optical systems. Therefore, commercially available antireflective coatings with their low but significant amount of reflections are insufficient for use in high quality optical systems. Although the very best antireflective coatings can reduce reflections to about 0.1%; and although these coatings are effective for removing ghost reflections, they are expensive and are thus restricted to a narrow range of products. Consequently, the very best antireflective coatings are limited to products which are not sensitive to high cost. However, since many optical systems are quite sensitive to high cost, using an expensive antireflective coating is not attractive. For the highest quality optical systems, it is desired to reduce the ghost reflected image to less than 0.01%. Even the best antireflective coatings have not been able to achieve this level in practice. For these reasons, antireflective coatings by themselves on optical components or optical elements for use in high quality optical systems are not sufficient for reducing or eliminating ghosting reflections.

As an alternative to antireflection coatings, if the distance between optical components or optical elements is small, the resulting gap can be filled by a liquid adhesive. If the liquid adhesive is chosen to match the index of refraction of the optical components or elements, then reflections are reduced at the interface there between. However, in many optical systems, adjustability of optical components or optical elements is necessary, and cementing optical elements together with a liquid adhesive restricts this required adjustability since a fairly large range of adjustability is needed in a product. Therefore, in many situations, adhesives are not viable for high quality optical systems.

In some situations, it is also possible to use an index matching material such as a liquid or a gel in the gap to minimize reflections. Initially, these fluids may work well, although problems can occur as the liquid or gel repositions itself. The repositioning may cause birefringent properties or potential voids in the material and thereby reduce the optical quality. Furthermore, at elevated temperatures, for example, due to the use of high intensity light sources in projector systems, the liquid can thermally convect thereby creating undesirable shimmer. Finally, the liquid or gel is susceptible to leaking. For these reasons, uses of liquids or gels in the gaps between optical elements or optical components are not attractive for high quality optical systems.

Therefore, there is a need to develop a more effective solution to the problem of maintaining adjustability of optical components and optical elements while essentially eliminating ghost reflections in optical systems.

### BRIEF DESCRIPTION OF THE DRAWINGS

The exemplary embodiments of an optical system are better understood with reference to the following drawings. The elements of the drawings are not necessarily to scale relative to each other; rather, emphasis has instead been placed upon clearly illustrating the embodiments of the optical system. Furthermore, like reference numerals designate corresponding similar parts through the several views.

FIG. 1 is a partial cross sectional close up view of two optical elements, a path of a light beam, and reflections according to an exemplary embodiment of an optical system.

FIG. 2 is a cross sectional diagram of an exemplary embodiment of an optical system as applied to a three prism total internal reflection (TIR) projection system.

FIG. 3 shows a perspective diagram of total internal reflection (TIR) prisms for a three color projection system and a path of a light beam according to an exemplary embodiment of an optical system.

FIG. 4 shows a perspective diagram of the path of the light beam for one of the colors in a three light modulator projection system according to an exemplary embodiment of an optical system.

FIG. 5 shows a perspective view of the path of the light beam for another color in a three light modulator projection system according to an exemplary embodiment of an optical system.

FIG. 6 shows a perspective view of the path of the light beam for yet another color in a three light modulator projection system according to an exemplary embodiment of an optical system.

FIG. 7 is an exemplary process flow diagram showing a set of procedural acts for aligning the optical elements according to an exemplary embodiment of an optical system.

### DETAILED DESCRIPTION

The exemplary embodiments of an optical system are directed to an apparatus and adjustment method for positioning one optical element relative to another optical element for minimizing unwanted reflections e.g. ghosting or the like. The exemplary implementations reduce the unwanted reflections from optical elements by directing the reflections at an angle away from the path of the light beam such that the reflections are at an angle that does not contribute to ghosting. In accordance with certain implementations of an optical system, comatic aberration and astigmatism can be corrected by using standard optical techniques known by persons skilled in the art.

The exemplary embodiments of an optical system find use in optical systems where it is important to reduce reflections. Examples of positioning optical components are, but are not limited to, alignment of a light modulator to a projection prism, a photo-emitter to a photo-detector, a fiber-optic to a lens, and a projection lens or a projection prism onto a photo-sensor or photo-array. The exemplary embodiments of an optical system also find application in other optical systems where reflections may reduce image quality such as microscopes, cameras, binoculars and analytical imaging equipment.

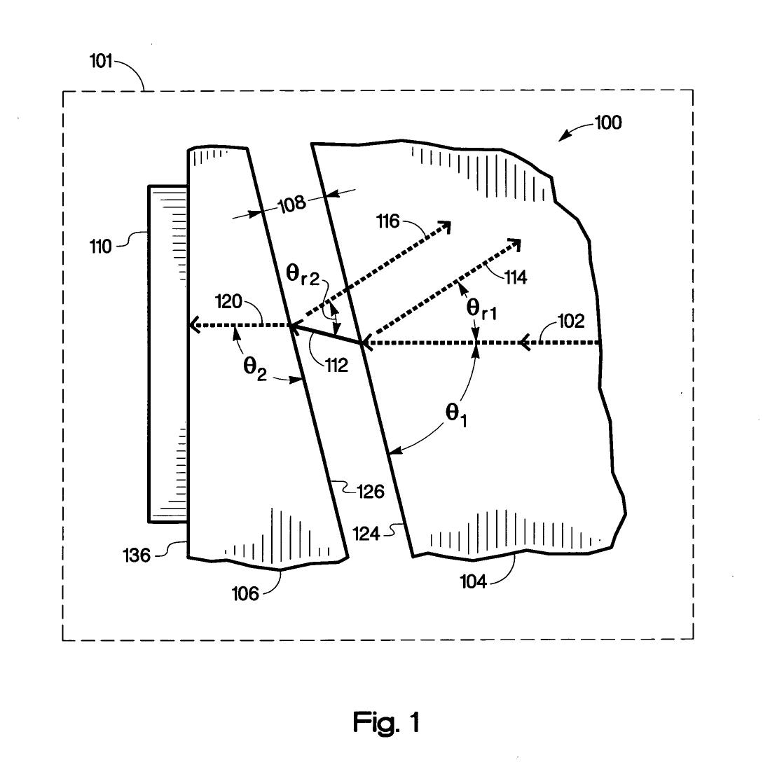

FIG. 1 shows an optical assembly apparatus 100 having two optical elements 104 and 106, an optical component 110 and a light beam 102 according to one exemplary embodiment of an optical system. An optical assembly apparatus 100 may be a subcomponent of an optical projector 101. A first optical element 106 is positioned facing a second optical element 104 such that a gap 108 is formed between a first surface 126 of the first optical element 106 and a first surface 124 of the second optical element 104. The first optical element 106 can be wedge shaped and the second optical element 104 can be a portion of a prism. The optical elements can be made of an optical glass such as BK7, quartz, sapphire or the like. An optical component 110 is mounted or otherwise arranged on a second surface 136 of the first optical element 106. The optical component 110 may be, for example, a light modulator. The optical component 110 may be fixed by an adhesive or clamped to surface 136. The first surfaces 124 and 126 are shown to be planar, although they can have some curvature or surface properties which can focus, adjust, or alter light. The first surfaces 124 and 126 are shown to be substantially parallel to each other and at an angle θ₁ to a path of a light beam 102. Although the first surfaces 124 and 126 are parallel for the least amount of optical aberration, the first surfaces 124 and 126 do not necessarily have to be parallel. The first surfaces 124 and 126 may actually be non-parallel due to the positional adjustments required to align the first optical element 106 to the second optical element 104. Also, the first surfaces 124 and 126 may be non-parallel due to an optical design requirement. The gap 108 may be filled with air or other materials. The index of refraction of the gap 108 may be higher or lower than the first optical element 106 and the second optical element 104. Also, the first optical element 106 and the second optical element 104 can have different indices of refraction.

The path of the light beam 102 passes through the second optical element 104. The path of the light beam 102 is shown to be straight and direct into the second optical element 104 for illustrative purposes, but when an image is projected through the second optical element 104, the projected image is actually made up of many paths of light. In describing an exemplary embodiment of an optical system, a path of a light beam 102 is shown for clarity, yet the path of the light beam 102 does not completely render an image and other paths of light may be needed. A person skilled in the art understands how other paths of light can either be convergent, parallel, or divergent to the path of the light beam 102 to completely render an image.

A path of the light beam 102 passes through the second optical element 104 and strikes the first surface 124 of the second optical element 104 at an angle θ₁. The path of the light beam is redirected into two components upon hitting the first surface 124 of the second optical element 104 due to the refractive index mismatch which occurs between the second optical element 104 and the gap 108. The first redirected component of the path of the light beam 102 forms a reflection 114 from the first surface 124 of the second optical element 104 and the second redirected component of the path of the light beam 102 is refracted 112 at the first surface 124 of the second optical element 104. The reflection 114 is directed away from the path of the light beam 102 at an angle θᵣ₁ with respect to the path of the light beam 102. It is this angle of reflection, θᵣ₁ that steers the undesirable reflection 114 away from the path of the light beam 102 and therefore substantially reduces or essentially eliminates the possibility of a ghost reflection 114. In a particular design for an optical projector, the angle θ₁ has been chosen to be about 85 degrees; however, the angle θ₁ is thus not limited, but depending upon application and design constraints, the angle θ₁ can be chosen to satisfy other optical system design criteria, for instance, the numerical aperture of the imaging path.

If the angle θ₁ is about 90 degrees, then the reflection 114 reflects directly back in line with the path of the light beam 102 thereby creating a possibility of a ghost reflection. If θ₁ is at a very low angle, for instance 30 degrees or less, then there is a possibility of no refraction 112 of light through the gap from the path of the light beam 102 because the light will be totally internally reflected 114. If the index of refraction n₁ of the second optical element 104 is greater than the index of refraction n₂ of the gap 108, then the total internal reflection angle (θ_{TIR}) of the path of the light beam is a function of the index of refraction of the optical element 104 and the gap 108 according to Equation 1.

$$\begin{matrix}Equation 1 \text{:} & \\ {θ}_{TIR} = \begin{matrix}Π \\ 2\end{matrix} - {sin}^{- 1} ( \begin{matrix}{n}_{2} \\ {n}_{1}\end{matrix} ) & \end{matrix}$$

Where n₁ is the index of refraction of the second optical element 104, n₂ is the index of refraction of the gap 108, and π/2 is a constant angle in radians which is equivalent to 90 degrees.

As an example, since BK7 is a glass for an optical element and has an index of refraction of about 1.5 and a gap is air and has an index of refraction of about 1, then the total internal reflection angle calculated from Equation 1 is about 48 degrees. Therefore, if the angle θ₁ is less than about 48 degrees, the path of the light beam 102 will be totally internally reflected 114 and the light will not be refracted 112. In other words, the light will not be transmitted through the air gap 108. In the case where BK7 glass is used for optical elements, and the optical elements are separated by air, the angle θ₁ of the path of a light beam 102 ranges from more than 48 degrees to avoid internal reflection but less than 90 degrees to avoid ghosting. An angle less than 90 degrees reduces the ghosting reflection 114 by redirecting the reflected 114 light away from the path of the light beam 102. An angle of more than 48 degrees avoids total internal reflection and allows the refraction 112 of the light beam 102 to pass through optical element 104 and gap 108. In this example BK7 and an air gap are provided to help explain an exemplary embodiment of an optical system and is therefore not limiting. Different optical elements and gaps can be used which have different optical properties such as refractive indices and may yield different ranges of angles.

Although the total internal reflection angle θ_{TIR} has been calculated using angle θ₁, the total internal reflection angle θ_{TIR} can be calculated using the reflected angle θᵣ₁. which is formed between the path of the light beam 102 and the reflected light beam 114. If the light beam 102 is perpendicular to the surface 124 of the second optical element 104, the reflected angle θᵣ₁ will be zero degrees. If the light beam 102 is essentially parallel to the surface 124 of the second optical element 104, the reflected angle θᵣ₁ is essentially 180 degrees. One skilled in the art of optics will understand that transmitted light, refracted light, and the total internal reflection angle can be calculated from the angle θᵣ₁ which occurs between the light beam 102 and a reflected 114 light beam from surface 124.

As a specific example, for a design of an optical system having a given numerical aperture, the angle θ₁ is chosen as 85 degrees. This 85 degree angle for θ₁ is equivalent to a 10 degree angle for θᵣ₁. Therefore, the first and second reflections 114 and 116 are at a 10 degree angle relative to a path of the light beam 102.

A main optical system constraint which may help the designer determine the proper choice of angle θ₁ or θᵣ₁ is the numerical aperture of the optical system. Low numerical aperture optical systems have a narrow angle of light gathering ability. Therefore, a relatively small angle can be chosen for θᵣ₁ to reduce ghosting because the light is reflected 114 outside of the relatively narrow acceptance angle defined by the low numerical aperture and does not interfere with light traveling along or parallel to the path of the light beam 102. High numerical aperture systems have a wide angle of light gathering ability, and therefore a relatively larger angle can be chosen for θᵣ₁ so that light is not reflected 114 along the path of the light beam 102.

The refracted light beam 112 propagates through the gap 108 and strikes the first surface 126 of the first optical element 106. Part of the refracted light beam 112 is reflected 116 off the first surface 126 of the first optical element 106 at an angle θᵣ₂ and part of the refracted light beam 112 is refracted 120 at an angle θ₂ through the first optical element 106. The reflection 116 and refraction 120 occur because of the index of refraction mismatch that occurs between the gap 108 and the optical element 106. Since the reflected path of light 116 is shown to be at a significantly different angle θᵣ₂ than the direction of the light beam 102, the possibility for ghosting is essentially eliminated. The refracted light beam 120 is substantially perpendicular to the second surface 136 of the first optical element 106.

An optical component 110 is mounted on the second surface 136 of optical element 106. The optical component can be mounted by a clamp or other mechanical fasteners, an optical adhesive, or the like (not shown). The optical adhesive can fill the void between optical component 110 and first optical element 106 creating an index match which minimizes unwanted reflections from second surface 136. Gap filling liquids or gels to limit unwanted reflections could also be used with clamps, frames, fasteners, or the like. It is desirable to mount the optical component 110 to first optical element 106 in a direct manner to reduce reflections since little adjustability is required between optical component 110 and first optical element 106. However, as described in the background section, it is undesirable to use an optical adhesive or a liquid to match the index of the first optical element 106 to the second optical element 104, by filling the gap 108 with an optical adhesive or a liquid.

The refracted light beam 120 strikes an optical component 110 such as, for example, but not limited to, an optical modulator. The optical component 110 as an optical modulator can vary the reflected light intensity from near 0% reflection, thereby rendering a reflected light beam from the optical modulator fully off (not shown), to near 100% reflection, thereby rendering the reflected light beam fully on (not shown). The amount of reflection can be controlled by modulating the dwell time of mirrors to control the brightness, modulating the brightness based on absorption of the light due to interference from an optically tuned cavity, modulating the amount of light based on polarization techniques such as liquid crystals, or other techniques.

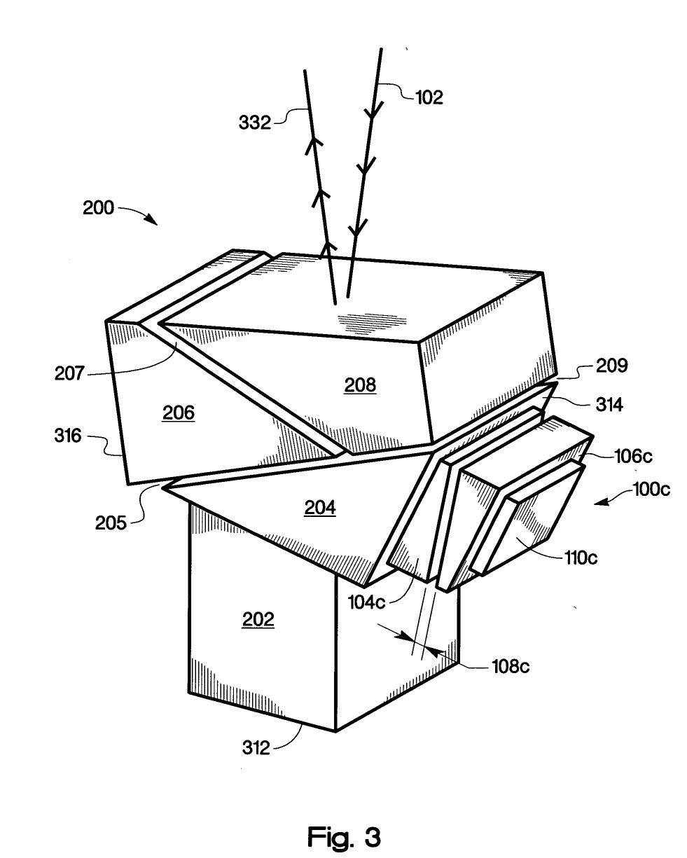

Although the path of the reflected light beam from refracted light beam 120 is not shown for clarity, it is back along the path of the light beams 120, 112, and 102. The reflected light beam is not shown because the path of the light beam would have to be drawn over light beams 120, 112, and 102 thereby causing potential confusion. However, as shown in FIG. 3, the reflected light beam 332 is shown angled toward the viewer. The reflected light beam from the optical component 110—functioning as an optical modulator—is actually angled towards the viewer as shown and described in reference to FIGS. 3-6.

As mentioned previously, the path of the light beam 102, refracted light beam 112, and refracted light beam 120 represent a single ray of an image. However, an image can be made up of many thousands or millions of paths of light beams simultaneous traveling through second optical element 104, gap 108 and first optical element 106. When the optical component 110 is an optical modulator, the thousands or millions of paths of light beams which make up the image are correspondingly reflected with various degrees of intensity by the individual pixels in the optical modulator thereby rendering an image.

The exemplary embodiment of an optical system shown in FIG. 1 allows physical adjustability of optical component 110 with respect to optical element 104. If the optical component 110 is an optical modulator, it can be precision aligned to the second optical element 104 which could be an optical prism. In a projection system having three optical modulators and three prisms, this exemplary embodiment of an optical system allows precision alignment of the images on a pixel by pixel basis from each of the three optical modulators relative to each other while essentially eliminating the inherent reflection problem causing ghosting.

Using this exemplary embodiment of an optical system as shown in FIG. 1, the adjustability of the optical component 110 relative to the optical element 106 is retained while reflections in the direction of the path of light beam 102 are minimized to a level of about 0.002% without resorting to antireflective coatings or gap filling index matching fluids or adhesives.

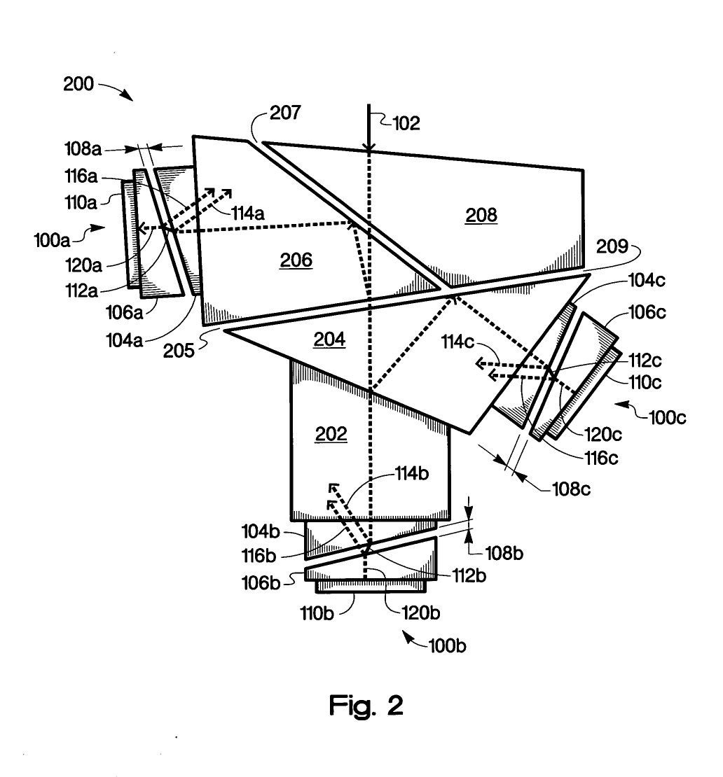

FIG. 2 shows a totally internal reflecting (TIR) prism assembly 200. Each of the three subcomponent assemblies in the projection system and the reference numbers used in FIG. 1 are suffixed by a, b, or c. The three modulators each render individual colors of red, green, and blue and thereby form a gamut of color. Other colors can be used, or even added to the optical assembly to improve or alter the color gamut. Also, this exemplary embodiment of an optical system does not require the use of all three subcomponent optical assemblies 100a, 100b, and 100c. For example, the optical assembly 100 as shown in FIG. 1 can be used alone with an optical modulator where each pixel is capable of dynamically rendering red, green, or blue. In another exemplary embodiment of an optical system, the subassembly in FIG. 1 may be used with a modulator where the colors red, green, and blue are arranged spatially on the modulator in a mosaic pattern.

In yet in another exemplary embodiment of an optical system, the subassembly in FIG. 1 may be used with a modulator where the colors are rendered using a rotating color wheel filter (not shown). The rotating color wheel filter usually has colors of red, green, and blue, but other colors can be added to the color wheel such as, but not limited to, yellow, cyan, and magenta.

The TIR prism assembly 200 as shown in FIG. 2 has a modulator and prism for each of three colors red, green, and blue. The color red is rendered in the “b” subassembly, the color green is rendered in the “a” subassembly, and the color blue is rendered in the “c” subassembly. Other colors may also be used

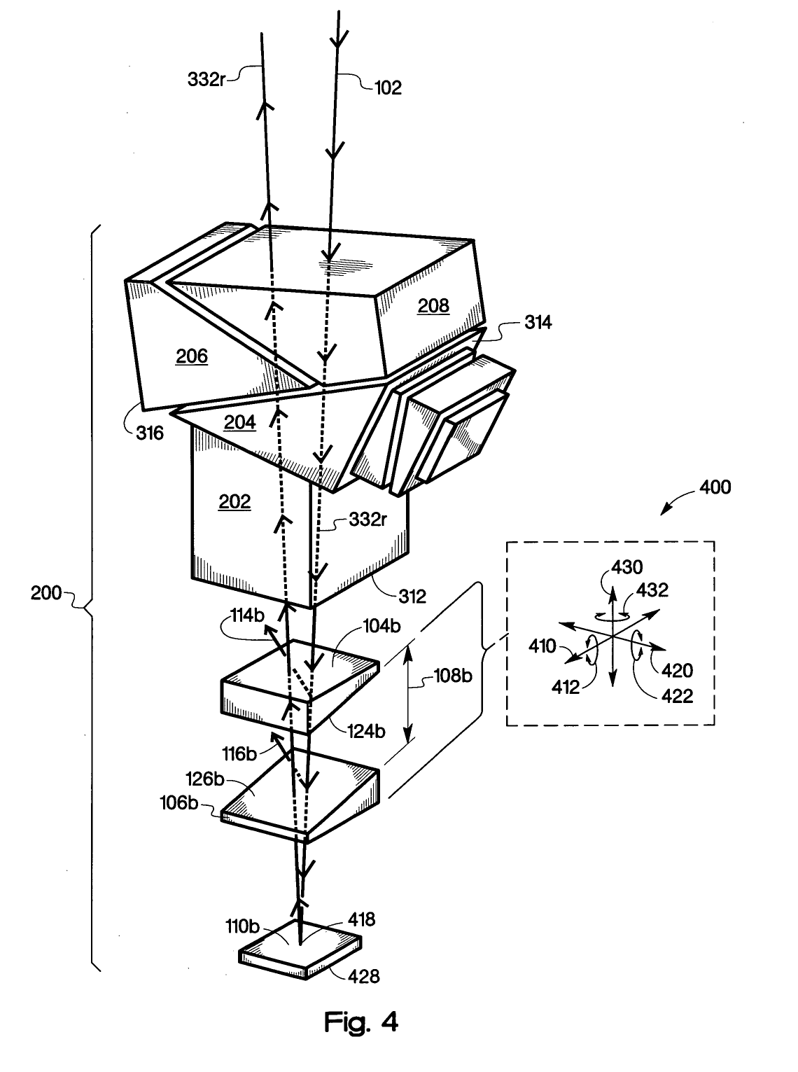

When the optical component 110 is an optical modulator, precision alignment of each optical modulator with respect to each other optical modulator is required to obtain a quality image. For a quality image, each projected pixel of the optical modulator needs to superimpose a precisely controlled amount of red, green, and blue onto each other. Alignment and adjustability is accomplished by positioning optical element 106 with respect to optical element 104. Adjustability is allowed by gap 108. The wedge shaped optical elements 104 and 106 redirect reflections 114 and 116 away from the path of the light beams 102 and 112; thereby essentially eliminating ghost reflections as described in reference to FIG. 1. Total internal reflection gaps 205, 207, and 209 are used to direct the path of the light beam 102 between prisms 204, 206, and 208. Prism 202 is directly mounted to prism 204 without a gap. Prism 208 is used for mounting other optical components to, for example, a lens assembly. The path of the light beam 120 hits the optical component 110. A detailed description for the path of the light beam 102 for each of the three colors is described in reference to FIGS. 4-6.

FIG. 3 shows the TIR prism assembly 200. This prism assembly can be used in a color projector having three light modulators. This TIR prism assembly 200 has a greater light output given the same lamp intensity than a projector with a color wheel filter (not shown). One of the optical assemblies 100c is shown having an optical modulator as the optical component 110c, the first optical element 106c, the second optical element 104c and the gap 108c. The prisms 202, 204, 206, and 208 are transparent, and the three light modulators each render a component of an image in red, green, and blue.

The base of the TIR prism assembly 200 is a prism 202 having a surface 312. The optical assembly 100b of FIG. 2 (not shown in FIG. 3) is mounted to the surface 312 of the prism 202 for the purpose of rendering the red component of the image. A prism 204 is mounted to the prism 202 and the optical assembly 100c is mounted to a surface 314 of the prism 204 for the purpose of rendering the blue component of the image. A prism 206 is mounted proximate the prism 204 where a gap 205 exists between prisms 204 and 206. The gap 205 functions as a totally internally reflecting surface, and is about 10 microns, although the gap distance may vary according to application. The optical assembly 100a of FIG. 2 (not shown in FIG. 3) is mounted to a surface 316 of the prism 206 for the purpose of rendering the green component of the image. A prism 208 is mounted proximate the prisms 204 and 206 where a gap 207 exists between the prism 206 and the prism 208, and a gap 209 exists between prisms 204 and 208. A gap 209 also exists between prisms 204 and 206. Gaps 207 and 209 function as a totally internally reflecting surface. Gap 207 and gap 209 are about 10 microns, although the gap distance may vary according to application. The prisms, gaps, and optical assemblies will be described in more detail in reference to FIGS. 4-6. Although each of the prisms 202, 204, and 206 have been described to render the colors red, blue, and green respectively, it is also possible that the prisms can render other colors. For example, prism 202 could be configured to render green or blue, prism 204 can render green or red, and prism 206 can render red or blue. Other colors such as yellow or variations of blue or red, such as cyan or magenta may also be used to achieve a different color gamut. Although three optical assemblies 100, each mounted to an optical prism, have been described, it is possible that the optical component 110c can be directly mounted to surface 314 of optical prism 204 without optical elements 104c and 106c. The other two optical assemblies 100a and 100b shown in FIG. 2 can be mounted to surfaces 316 and 312 of prisms 206 and 202 respectively. These two optical assemblies 100a and 100b can then be aligned to the optical component 110c which has already been directly affixed to the surface 314 of prism 204.

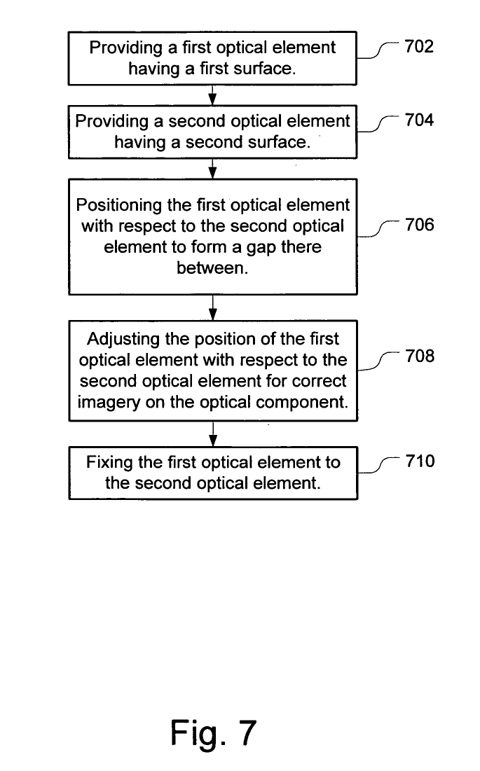

Light beam 102 enters the TIR prism assembly 200 and is separated into red, green, and blue. Each color is directed to one of the three light modulators where images are formed, one for each of the three colors. The three separate colored images are aligned pixel by pixel and superimposed to form a gamut colored image from light beam 332 which exits from the TIR prism assembly 200. To render quality images, the three light modulators are spatially aligned with respect to each other. This alignment is accomplished using the optical components and optical elements described in reference to FIGS. 1 and 2 and the procedure in reference to FIG. 7. Although the exemplary embodiment of an optical system has been shown on a TIR prism assembly 200 having three colors, this exemplary embodiment is not limited to three colors, three prisms, nor projector systems. This exemplary embodiment can be used for projectors having more or less than three prisms or more or less than three colors. Also, this exemplary embodiment is not limited to projectors, as it finds application in areas including, but not restricted to: aligning optical plates, optical filters, optical lens, photodiodes, photodiode arrays, photodiode matrices, optical fibers, and in opto-electronic devices. This exemplary embodiment also finds application to systems including, but not limited to, rangefinders, magnifiers, binoculars, cameras, spectrometers, microscopes, analytical equipment, optical communication equipment, fabrication equipment, or wherever it is desirable to reduce or essentially eliminate reflections caused by ghost images.

FIG. 4 shows the TIR prism assembly 200 of FIG. 3 for rendering a red image. However, as previously mentioned, although each of the prisms 202, 204, and 206 have been described to render the colors red, blue, and green respectively, it is also possible that the prisms can render different colors. For example, prism 202 could be configured to render green or blue, prism 204 can render green or red, and prism 206 can render red or blue. Other colors such as yellow or variations of blue, green, cyan, magenta, or other colors may also be used in prism 202 to achieve a different color gamut. Therefore, although FIG. 4 shows the color red being rendered, the colors green, blue, or another color could be rendered without deviating from the exemplary embodiment of an optical system. The optical elements 104b and 106b, the gap 108b, and the optical component 110b are mounted to surface 312 of prism 202, although for illustration they are shown using an exploded view.

The optical elements 104b and 106b can be positioned by operatively coupling an adjustment mechanism 400 to the optical elements 104b and 106b. The optical elements 104b and 106b can be independently positioned or jointly positioned in the x-axis 410, the y-axis 420, the z-axis 430, rotations about the x-axis 412, rotations about the y-axis 422, or rotations about the z-axis 432 using the adjustment mechanism 400. The adjustment mechanism 400 can take the form of a mechanical lead screw type of device, an electromechanical manipulator such as a piezo or an electromagnetic drive, or another type of drive or device.

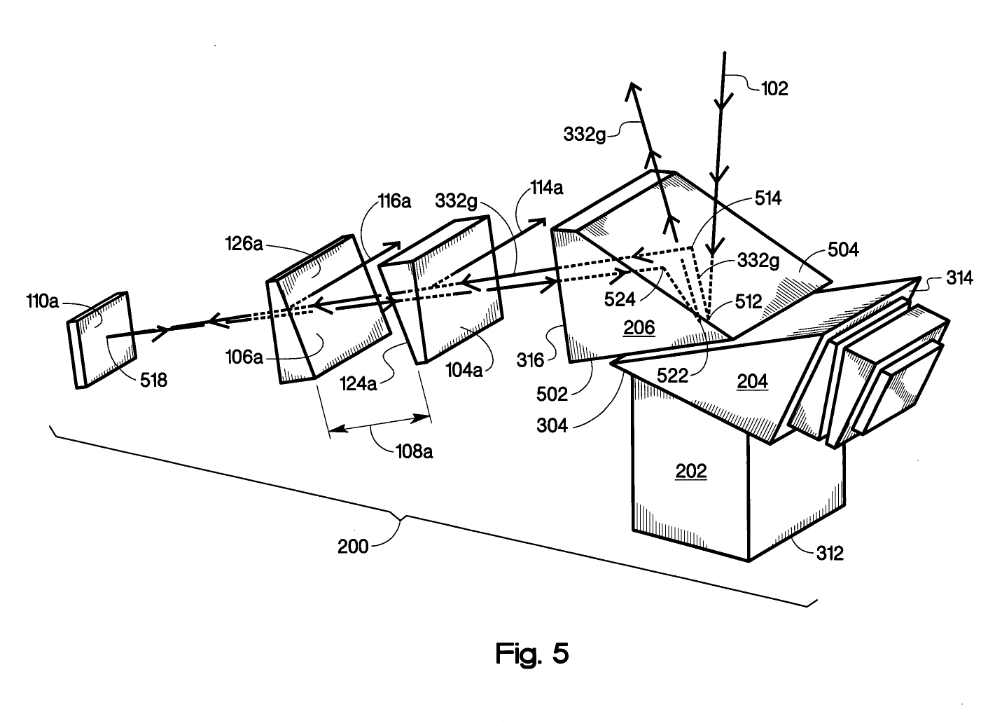

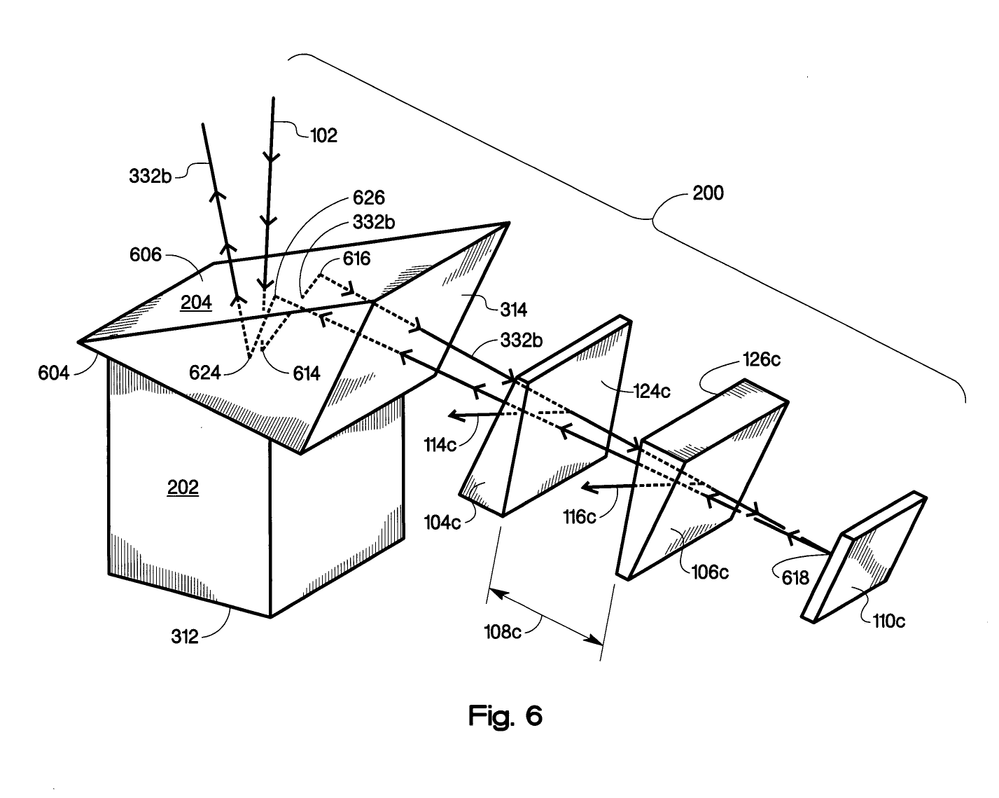

A white light beam 102 enters prism 208. The green and blue portions of the white light are reflected from coatings applied to prisms 204 and 206 which are further described in reference to FIG. 5 and FIG. 6. The red light beam 332r as a spectral component of the path of the white light beam 102 passes through the prisms 208, 206, 204, 202, the second wedge shaped optical element 104b, the gap 108b, and the first wedge shaped optical element 106b, where the red light beam 332r reflects 418 off optical component 110b, shown as an optical modulator. A control line 428 is operatively coupled to an optical component 110b such as an optical modulator for controlling the pixels on the optical modulator. The optical component 110b such as an optical modulator is physically coupled to the optical element 106b by clamping, gluing, use of an ultraviolet curable adhesive, or the like. The reflected red light beam 332r passes back through the first wedge shaped optical element 106b, the gap 108b, the first wedge shaped optical element 104b, and through the prisms 202, 204, 206, and 208 such that the red light beam, 332r renders a red portion of the image.

The reflection 114b from the first surface 124b of the second optical element 104b and the reflection 116b from the first surface 126b of the first optical element 106b are directed away from the light beam 332r such that the undesirable reflections do not project towards the rendered image, and therefore ghosting is essentially eliminated. As previously mentioned, the color red is exemplary, and other colors may be rendered.

Prism 202 is an optical component and therefore surface 312 serves as a base for which to mount the second optical element 104b. Alternatively, the surface 312 of prism 202 can be angled to perform the function of surface 124b of the second optical element 104b, such that the second optical element 104b is not necessary. The optical component 110b is positioned and aligned to the prism 202 using optical elements 104b, 106b, and gap 108b as described in reference to FIGS. 1 and 2 and the procedure in reference to FIG. 7.

FIG. 5 shows the TIR prism assembly 200 of FIG. 3 where prism 208 has been removed for clarity. FIG. 5 renders a green image, however, as previously mentioned each of the prisms 202, 204, and 206 have been described to render the colors red, blue, and green respectively, although it is also possible that the prisms can render different colors. For example, prism 202 could be configured to render green or blue, prism 204 can render green or red, and prism 206 can render red or blue. Other colors such as yellow, blue, red, cyan, magenta, or other colors may also be used in prism 206 to achieve a different color gamut. Therefore, although FIG. 5 renders the green portion of the image, the colors red, blue, or other colors could be rendered without deviating from the intent of the exemplary embodiment of an optical system. The optical elements 104a and 106a, the gap 108a, and optical component 110a are mounted to surface 316 of prism 206 as shown in an exploded view.

The white light beam 102 enters prism 206 where the green portion of the light beam 332g reflects 512 off a coated surface 502 while the red and blue light passes through surface 502. The green light beam 332g then reflects 514 off the surface 504 due to total internal reflection and passes through the second optical element 104a, the gap 108a, the first optical element 106a, and reflects 518 off the optical component 110a. The green light beam 332g then passes back through the first optical element 106a, the gap 108a, the second optical element 104a, and reflects 524 off the surface 504 due to total internal reflection and reflects 522 off the coated surface 502 which reflects green. The green reflected light beam 332g renders the green portion of the image. Note that surface 502 reflects the green light, while the red portion of the light beam 332r as shown in FIG. 4 passes through surface 502.

Reflections 114a from the first surface 124a of the second optical element 104a and reflections 116a from the first surface 126a of the first optical element 106b are directed away from the green light beam 332g such that the undesirable reflections do not project towards the rendered image, and therefore ghosting is essentially eliminated. As previously mentioned, the color green is exemplary, and other colors may be rendered.

Prism 206 is also an optical component and therefore surface 316 serves as a base for which to mount the second optical element 104a. Alternatively, the surface 316 of prism 206 can be angled to perform the function of surface 124a of the second optical element 104a, so that the second optical element 104a is not necessary.

For the best image quality, it is important to align the green light beam 332g as shown in FIG. 5 to the red light beam 332r as shown in FIG. 5. The optical component 110a is positioned and aligned to the prism 206 using optical elements 104a and 106a, and gap 108a as described in reference to FIGS. 1 and 2 and the procedure in reference to FIG. 7.

FIG. 6 shows the TIR prism assembly 200 of FIG. 3 where the prisms 206 and 208 have been removed for clarity. FIG. 6 renders a blue image, however, as previously mentioned, each of the prisms 202, 204, and 206 have been described to render the colors red, blue, and green respectively, it is also possible that the prisms can render different colors. For example, prism 202 could be configured to render green or blue, prism 204 can render green or red, and prism 206 can render red or blue. Other colors such as red, green, yellow, cyan, magenta, or other colors may also be used in prism 204 to achieve a different color gamut. Although prism 204 renders the color blue, the colors green, red, or other colors could be rendered without deviating from the intent of the exemplary embodiment of an optical system. Optical elements 104c and 106c, optical gap 108c, and optical component 110c are mounted to surface 314 of prism 204, but are shown using an exploded view.

A red and blue light beam 102 (green has been reflected off by a coating—not shown—on the surface 502 of prism 206 as shown in FIG. 5) enters prism 204 where the blue light beam 332b reflects 614 off a coated surface 604 which reflects the blue light beam 332b but allows the red light to pass. The blue light beam 332b then reflects 616 off surface 606 due to total internal reflection and passes through the second optical element 104c, the gap 108c, the first optical element 106c, and reflects 618 off optical component 110c. Then, the blue light beam 332b passes back through the first optical element 106c, the gap 108c, the second optical element 104c, and reflects 626 off surface 606 due to total internal reflection. Finally, the blue light beam 332b reflects 624 off surface 604, which has a coating to reflect blue, and the blue light beam 332b renders the blue portion of the image.

The reflection 114c from the first surface 124c of the second optical element 104c and the reflection 116c from the first surface 126c of the first optical element 106c are directed away from the light beam 332b such that the undesirable reflections do not project towards the rendered image, and therefore ghosting is essentially eliminated. As previously mentioned, the color blue is exemplary, and other colors may be rendered. Prism 204 is also an optical element and surface 314 therefore serves as a base for which to mount the second optical element 104c. Alternatively, the surface 314 of prism 204 can be angled to perform the function of the surface 124c of the second optical element 104c, such that the second optical element 104c is not necessary.

It is important for the blue light beam 332b of the image in FIG. 6, the red light beam 332r of the image in FIG. 4 and the green light beam 332g of the image in FIG. 5 to properly align to each other. Optical component 110c is positioned and aligned to the prism 204 using the optical elements 104c and 106c, and the gap 108c as described in reference to FIGS. 1 and 2 and the procedure in reference to FIG. 7. Alignments of the red, green, and blue portions of the image are required to render a quality image.

Although the colors red, green, and blue have been described in an embodiment of the optical system for illustrative purposes, the embodiments described herein can also be used for other optical wavelengths such as, but not limited to infrared, ultraviolet, or the like.

FIG. 7 shows the acts for aligning the optical assembly 100 shown in FIG. 1 according to an exemplary embodiment of an optical system.

In act 702, a first optical element 106 is provided as shown in FIG. 1. The first optical element 106 can be in the shape of a wedge having a first surface 126 and a second surface 136.

In act 704, a second optical element 104 is provided as shown in FIG. 1. The second optical element 104 can be in the shape of a wedge having a first surface 124. Alternatively the second optical element 104 can be a portion of another optical element, such as one or more prisms 202, 204, or 206 as shown in FIG. 3.

In act 706, the first surface 126 of the first optical element 106 is positioned such that it is facing the first surface 124 of the second optical element 104 and thereby forming a gap between the first surfaces 124 and 126 as shown in FIG. 1. Alternately, the first surface 124 of the second optical element 104 can be positioned such that it is facing the first surface 126 of the first optical element 106. The choice for a gap ranges from about 0.1 millimeters to about 10 millimeters. If a gap is used which is smaller than about 0.1 millimeter, and if the first surfaces 124 and 126 are rotatably positioned with respect to each other, then the first surface 126 of the first optical element 106 and the first surface 124 of the second optical element 104 may touch each other. This result should be avoided for quality images. However, if there is no danger of the optical elements touching each other, the gap can be reduced. A gap larger than about 10 millimeters may also be used, but optical aberrations associated with a larger gap tend to increase. These aberrations are coma and astigmatism, which are undesirable optical properties. A gap of about 1 millimeter is a design choice which allows for ample adjustment, yet is small enough for a compact design and creates a minimal amount of comatic aberration and astigmatism which can easily be corrected in an optical system.

In act 708, the first optical element 106 is adjusted with respect to the second optical element 104 to cause the path of the refracted light beam 120 to properly image on the optical component 110 as shown in FIG. 1. Alternately, the second optical element 104 can be adjusted relative to the first optical element 106. The optical component 110 may be, but is not limited to, an optical modulator. The adjustment mechanism may use of a lead screw type of system allowing translations in each of the three axes and rotations about each of the three axes. Other types of adjustment methods may be used, such as, but not limited to, a spacer or a precision step (not shown). A spacer may be placed between the optical elements for control of the gap whereas a precision step may be integrated around the perimeter of the optical components so as to space each element apart from each other thereby forming a gap.

Reflection 114 from the first surface 124 of the second optical element 104 and the reflection 116 from the first surface 126 of the first optical element 106 reflect in a different direction than the path of the light beam 102 as shown in FIG. 1. The angles θᵣ₁ and θᵣ₂ are chosen to be outside of the acceptance angle governed by the numerical aperture of the optical system so as to reduce ghosting. For example, the angles θᵣ₁ and θᵣ₂ can be relatively small for a low numerical aperture system, or the angles θᵣ₁ and θᵣ₂ can be relatively large for a high numerical aperture system. However, the angle θᵣ₁ should not be chosen such that total internal reflection occurs; otherwise, light will not be transmitted through the optical elements 104 and 106.

In act 710, once the first optical element 106 is positioned correctly with respect to the second optical element 104 as shown in FIG. 1, the optical elements are fixed into position. When the position adjustment mechanism is a lead screw, the lead screw mechanism by inherent friction or preload can fix an optical element into position. An adhesive can also be used to lock a mechanical assembly in place.

Another way to fix the optical elements into position is to use a curable adhesive, such as a time setting, temperature setting, or ultraviolet curing adhesive. The first optical element 106 can be fixed to the second optical element 104 by clamping or preloading the optical elements together. There are many other ways to fix optical element into position such as by clamping, use of a frame or nest to hold the optical component 110, and therefore, this exemplary embodiment of an optical system is not limited to the exemplary methods described herein.

While the present embodiments of optical systems have been particularly shown and described with reference to the foregoing preferred and alternative embodiments, those skilled in the art will understand that many variations may be made therein without departing from the invention as defined in the following claims. This description of the embodiments of optical systems should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application.

What is claimed is:

1. An apparatus comprising:
a first optical element and a second optical element each having first surfaces;
wherein the first optical element has a second surface, wherein the thickness of the first optical element varies between the first and second surfaces;
wherein the first and the second optical elements are arranged such that the first surfaces are facing each other and spaced apart from one another to form a gap there between;
wherein an index of refraction mismatch occurs at each of the first surfaces as a result of the gap;
wherein at least one reflection occurs from a light beam hitting an index of refraction mismatch;
wherein the reflection is at a nonzero angle relative to a path of the light beam; and
wherein the second surface of the first optical element is substantially perpendicular to the path of the light beam.

2. The apparatus in claim 1, wherein the first surface of the first optical element and the first surface of the second optical element each have substantially planar first surfaces.

3. The apparatus in claim 2, wherein the first surface of the first optical element and the first surface of the second optical element are substantially parallel to one another.

4. The apparatus in claim 1, wherein the nonzero angle is between one degree and a total internal reflection angle.

5. The apparatus in claim 1, wherein the gap has an average width between about 0.1 millimeter and about 10 millimeters.

6. The apparatus in claim 1, wherein the gap presents an index of refraction that is different from an index of refraction of the first optical element and an index of refraction of the second optical element.

7. The apparatus in claim 1, wherein the first optical element has an index of refraction which is different than the index of refraction of the second optical element.

8. An optical assembly comprising:
a first optical element having substantially planar first and second surfaces;
wherein, the second surface is not parallel to the first surface;
a second optical element having a substantially planar first surface;
wherein, the first optical element and the second optical element are arranged such that the first surfaces are facing each other and spaced apart from one another to form a gap there between;
wherein a first reflection occurs from a path of a light beam hitting the first surface of the second optical element, and a second reflection occurs from the path of the light beam hitting the first surface of the first optical element;
wherein the first and second reflections are at a nonzero angle relative to a path of the light beam; and
wherein the second surface of the first optical element is substantially perpendicular to the path of the light beam.

9. The apparatus in claim 8, wherein at least a portion of the first optical element has a wedge shape and at least a portion of the second optical element has a prism shape.

10. The apparatus in claim 8, wherein the first optical element has an index of refraction which is different than the second optical element.

11. The apparatus in claim 8, wherein the first surface of the first optical element and the first surface of the second optical element are not arranged equidistant from one another.

12. The apparatus in claim 8, wherein the nonzero angle is about 10 degrees.

13. The apparatus in claim 8, wherein the gap has an average width of about one millimeter.

14. The apparatus in claim 8, wherein the first optical element has a second surface, the apparatus further comprising:
an optical modulator arranged on the second surface of the first optical element.

15. The apparatus in claim 8, wherein an index of refraction presented by the gap is different than an index of refraction of the first optical element and an index of refraction of the second optical element.

16. A method comprising;
providing a first optical element that includes a first planar surface and a second planar surface non-parallel to the first planar surface;
providing a second optical element that includes a first planar surface;
positioning the first optical element with respect to the second optical element such that the first planar surfaces of the first and second optical element face each other and are spaced apart from each other to form a gap there between; and
adjusting the position of at least one of the optical elements with respect to the other optical element such that if a path of a light beam strikes the first surface of each of the optical elements, a reflection occurs at each surface, and each of the reflections are at a non-zero angle relative to the path of the light beam.

17. The method in claim 16, wherein positioning the first surface of the first optical element with respect to the first surface of the second optical element is substantially parallel.

18. The method in claim 16, wherein positioning the first optical element with respect to the second optical element creates a non-zero angle relative to the path of light, the non-zero angle which is greater than about one degree and less than a total internal reflection angle.

19. The method in claim 16, wherein positioning the first surface of the first optical element relative to the first surface of the second optical element forms an average gap distance between 0.1 millimeter to 10 millimeters.

20. The method in claim 16, further comprising:
fixing the position of the first and second optical elements.
